(19) United States
(12) Patent Application Publication
(10) Pub. No.: US 2010/0174766 A1
(43) Pub. Date: Jul. 8, 2010

(54) Magnetic Precession Based True Random Number Generator

(75) Inventors: Thomas Weeks, Burnsville, MN (US); Yong Lu, Edina, MN (US); Xiaobin Wang, Chanhassen, MN (US)

Correspondence Address: Fellers, Snider, Blankenship, Bailey & Tippens, PC;(Seagate Technology LLC), 100 North Broadway, Suite 1700, Oklahoma City, OK, 73102-8820, US

(73) Assignee: Seagate Technology LLC, Scotts Valley, CA (US)

(21) Appl. No.: 12/349,354

(22) Filed: Jan. 6, 2009

(51) Int. Cl. G06F 7/58

(52) U.S. Cl. 708/255

(57) ABSTRACT

A method and apparatus for generating a random logic bit value. In some embodiments, a spin polarized current is created by flowing a pulse current through a spin polarizing material. The spin polarized current is injected in a free layer of a magnetic tunneling junction and a random logical bit value results from a variation in pulse current duration or a variation in thermal properties.

### BACKGROUND

As more and more private data is sent over open channels, fast and reliable encryption technologies become increasingly critical. Any good cryptography requires good random numbers to generate encryption keys that are completely unpredictable to attackers, including those who know how the random number generator is designed.

Many conventional algorithms available for generating pseudo-random numbers produce a repeatable sequence of digits based on a seed value. However, since such a sequence is generated by a deterministic process, it is inherently predictable, and thus unsuitable for strong encryption.

In contrast, a true random number generator (TRNG) uses a non-deterministic source to produce randomness. Most operate by measuring unpredictable natural processes, such as thermal (resistance or shot) noise, atmospheric noise, or nuclear decay.

In devices that utilize random numbers for operation, it is often desirable to increase efficiency and accuracy of random number generation.

### SUMMARY

Various embodiments of the present invention are generally directed to a method and apparatus for generating a random logic bit value.

In accordance with various embodiments, a spin polarized current is created by flowing a pulse current through a spin polarizing material. The spin polarized current is injected in a free layer of a magnetic tunneling junction and a random logical bit value results from a variation in pulse current duration.

In other embodiments, a control circuitry is configured to excite a spin polarized current by flowing a pulse current through a spin polarizing material. The spin polarized current is injected in a free layer of a magnetic tunneling junction and a random logical bit value results from using varying pulse current duration.

These and various other features and advantages which characterize the various embodiments of the present invention can be understood in view of the following detailed discussion and the accompanying drawings.

### BRIEF DESCRIPTION OF THE DRAWINGS

FIG. 1 is a functional representation of an exemplary data encryption device constructed and operated in accordance with various embodiments of the present invention.

FIG. 2 shows a random number generator cell operated in accordance with the various embodiments of the present invention.

FIG. 3 displays a random number generator cell operated in accordance with the various embodiments of the present invention.

FIG. 4 generally illustrates a manner in which a write operation can be conducted on a random number generator cell.

FIG. 5 generally illustrates a manner in which a read operation can be conducted on the memory cell of FIG. 4.

FIG. 6 shows a flow diagram for a randomize operation performed in accordance with the various embodiments of the present invention.

FIG. 7 provides graphical representations of pulse current durations used in accordance with various embodiments of the present invention.

### DETAILED DESCRIPTION

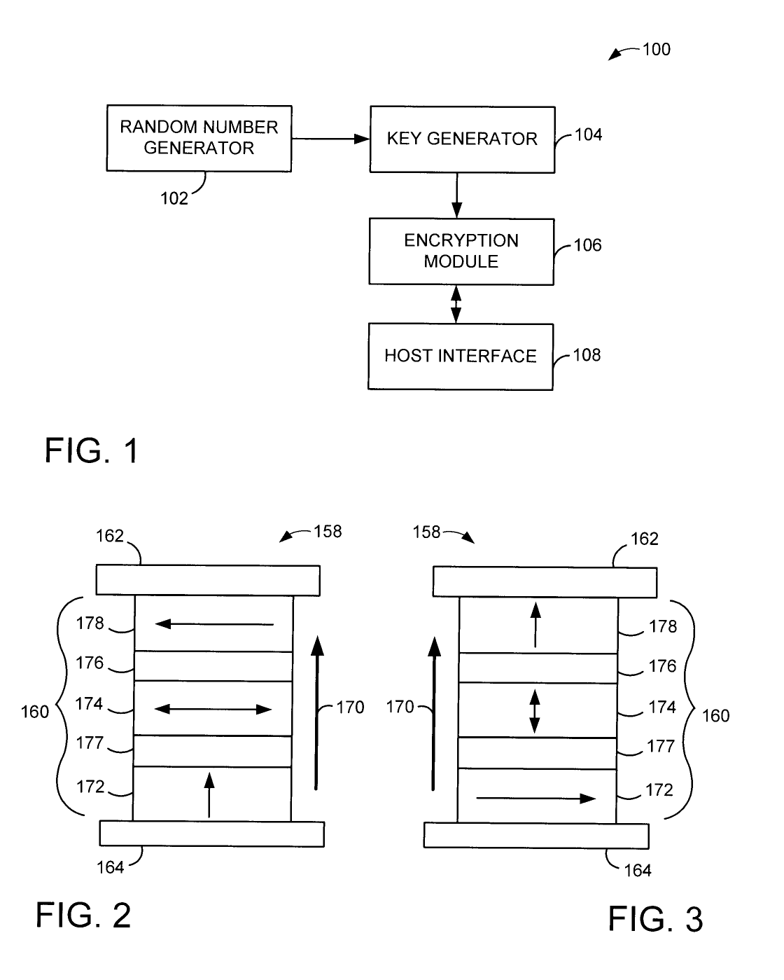

As noted above, various embodiments of the present invention are generally directed to the generation of random numbers. Random numbers can be utilized in a variety of applications, including but not limited to encryption-based digital data security systems. An illustrative environment for such random number generation is set forth in FIG. 1, which shows a data encryption device 100. In some embodiments, the data encryption device 100 can be a volatile or non-volatile storage device. It will be appreciated, however, that the various embodiments presented herein are not limited to a data storage device, but can rather be extended to any number of other types of operational environments, as desired.

FIG. 1 provides a functional block representation of a data encryption device 100 constructed and operated in accordance with various embodiments of the present invention. The data encryption device 100 is contemplated to be instrumented in various electronic equipment such as, but not limited to, communications and security protocol. It will be appreciated, however, that such characterization of the device 100 is merely for purposes of illustrating a particular embodiment and is not limiting to the claimed subject matter.

A random number generator 102 is utilized by a key generator 104 to create one or more suitable encryption keys. The encryption keys can vary depending on the encryption algorithm and desired application of the encryption. The key is transferred to an encryption module 106, which uses the key to encrypt data coming in from a host interface 108. Subsequently, the encrypted data and key are returned to the host for further processing via the interface 108.

It should be noted that the device 100 can be configured to include a random number generator that operates as discussed below to generate single or multi-bit random number values. Such values can provide a variety of functions for the encryption device 100 including, but not limited to, controlling host access to a memory space, encryption of data stored in a memory space, or encryption of communications between the device 100 and another device.

FIG. 2 displays a random number generator (RNG) cell 158 configured to operate in accordance with various embodiments of the present invention to generate random numbers. The RNG cell 158 includes a magnetic tunneling junction (MTJ) 160 positioned between a first electrode 162 and a second electrode 164. The MTJ 160 comprises a spin polarizer layer 172, a free layer 174 having soft magnetic properties, and a reference layer 178. A first tunnel barrier 177 facilitates spin injection from spin polarizer layer 172 to free layer 174. A second tunnel barrier 177 facilitates detection of the polarization of free layer 174. The magnetizations of free layer 174 and reference layer 178 are either parallel or anti-parallel to each other, and in some embodiments are perpendicular to the magnetization of the spin polarizer layer 172.

As the current pulse 170 flows through the cell 158, the spin polarizing layer 172 polarizes the spin of the current 170 in a direction perpendicular to the in-plane magnetization of the free layer 174 and injects the current 170 into the MTJ 160. The spin-polarized current 170 induces magnetization precession in free layer 174 that may settle into either parallel or anti-parallel magnetization relative to reference layer 178.

In some embodiments, the free layer 174 and reference layer 178 have the same magnetization, either in-plane or out-of-plane, that is perpendicular to the magnetization of the spin polarizing layer 172. The tunnel barriers 176, 177 can comprise oxide material or equivalent material sufficient to shield the magnetization of spin polarizing layer 172 from the free and reference layers 174 and 178. In addition, the tunnel barriers 176, 177 comprise material that shields the magnetization of the reference layer 178 from the free layer 174.

In further embodiments, the free layer 174 is a ferromagnetic material that has soft magnetic properties. The current pulse 170 passes through first and second tunnel barriers 176 and 177 that comprise oxide material that shields the reference layer's 178 and spin polarizing layer's 172 magnetic state from the free layer 174. The spin direction of the current pulse 170 dictates the magnetic phase of the free layer 174 and the resistive relationship of the cell 158 by the relationship between the free layer 174 and the magnetic phase of the reference layer 178.

FIG. 3 displays the RNG cell of FIG. 2 operated in accordance with various embodiments of the present invention. The current pulse 170 of FIG. 2 can flow through the cell 158. The current pulse 170 is excited by the spin polarizing layer 172 that polarizes the spin of the current in a perpendicular direction, which is a direction opposite to the spin torque that results when flowing a pulse current 170 in the opposing direction. The spin torque of the current pulse 170 induces the magnetic phase of the free layer 174 to either oppose the phase of the reference layer 178 and create a high resistive state for the cell 158 or be parallel to the reference layer and create a low resistive state.

A plurality of current pulses can be utilized to increase the randomization of a MTJ. For example, in one embodiment a MTJ 160 can be injected with a current pulse flowing from one direction and having a spin torque and subsequently injected with a current pulse from the opposing direction that has an opposing spin torque.

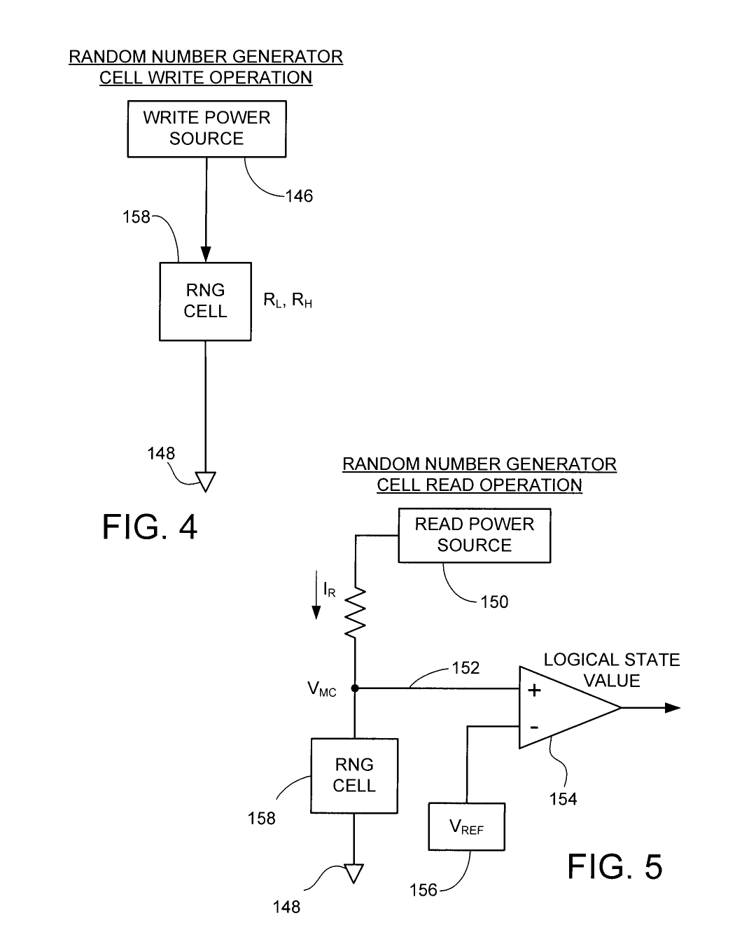

Data are written to the respective random number generator (RNG) cells 124 as generally depicted in FIG. 4. Generally, a write power source 146 applies the necessary input (such as in the form of current, voltage, magnetization, etc.) to configure the RNG cell 158 to a beginning state. It can be appreciated that FIG. 4 is merely a representative illustration of a RNG cell write operation. The configuration of the write power source 146, RNG cell 158, and reference node 148 can be suitably manipulated to allow writing of a selected logic state to each cell.

As explained below, in some embodiments the RNG cell 158 takes a modified STRAM configuration, in which case the write power source 146 is characterized as a current driver connected through a RNG cell 158 to a suitable reference node 148, such as ground. The write power source 146 provides a stream of power that is spin polarized by moving through a magnetic material in the RNG cell 158. The resulting rotation of the polarized spins creates a torque that changes the magnetic moment of the RNG cell 158.

Depending on the magnetic moment, the cell 158 may take either a relatively low resistance (R_{L}) or a relatively high resistance (R_{H}). While not limiting, exemplary R_{L} values may be in the range of about 100 ohms (Ω) or so, whereas exemplary R_{H} values may be in the range of about 100KΩ or so Other resistive memory type configurations (e.g., RRAMs) are supplied with a suitable voltage or other input to similarly provide respective R_{L} and R_{H} values. These values are retained by the respective cells until such time that the state is changed by a subsequent write operation. While not limiting, in the present example it is contemplated that a high resistance value (R_{H}) denotes storage of a logical 1 by the cell 158, and a low resistance value (R_{L}) denotes storage of a logical 0.

FIG. 5 illustrates the storage of logical bit value(s) by each cell 158 can be determined in a manner. A read power source 150 applies an appropriate input (e.g., a selected read voltage) to the RNG cell 158. The amount of read current I_{R} that flows through the cell 158 will be a function of the resistance of the cell (R_{L} or R_{H}, respectively). The voltage drop across the memory cell (voltage V_{MC}) is sensed via path 152 by the positive (+) input of a comparator 154. In some embodiments, a suitable reference (such as voltage reference V_{REF}) is supplied to the negative (−) input of the comparator 154 from a reference source 156.

The voltage reference V_{REF} can be selected from various embodiments such that the voltage drop V_{MC} across the RNG cell 158 will be lower than the V_{REF} value when the resistance of the cell is set to R_{L}, and will be higher than the V_{REF} value when the resistance of the cell is set to R_{H}. In this way, the output voltage level of the comparator 154 will indicate the logical bit value (0 or 1) stored by the RNG cell 158.

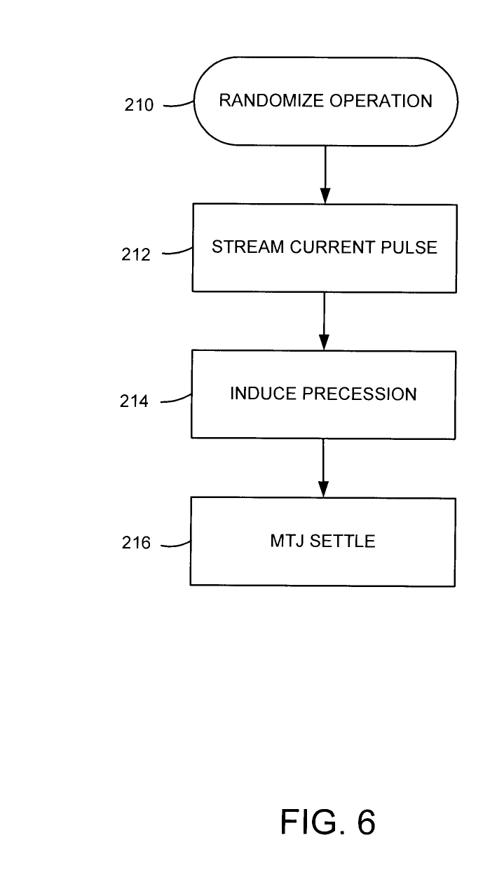

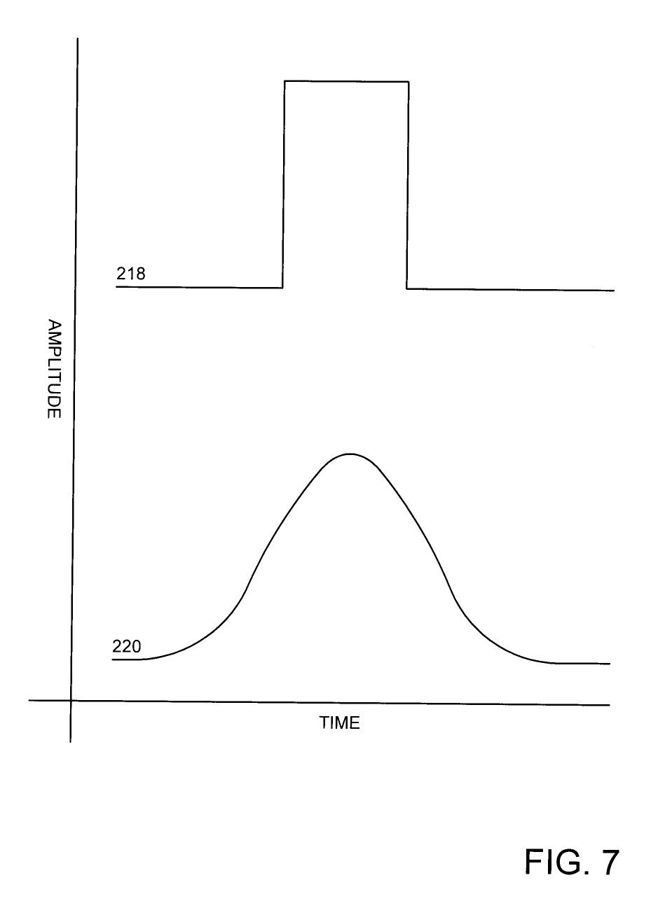

FIG. 6 displays a flow diagram of a randomize operation 210 performed in accordance with the various embodiments of the present invention. For a single MTJ 160 or an array, a current pulse is streamed to each MTJ at step 212 to begin the randomize operation 210. In some embodiments, an optimal current pulse width (or duration) is a pico-second for the randomize operation 210, such as generally represented in FIG. 7. However, embodiments of the present invention do not consistently provide a current pulse width of exactly a pico-second. Therefore, a distribution of current pulse width is achieved when attempting to stream a current pulse at a pico-second width, such as exemplified by a population distribution 220 in FIG. 7.

The variation in pulse width provides the fundamentally random element to the randomize operation 210 due to inability to precisely control the width of a current pulse near a pico-second, and accordingly, control (or even predict) the final magnetization orientation of the MTJ free layer. In various embodiments of the present invention, a nominally pico-second current pulse allows for generation of a true random number.

As the current pulse is injected into the free layer of each MTJ, a precession is possible that switches the magnetic phase of the free layer and places the memory cell in a high resistive state. The free layer of a MTJ has a certain magnetic moment as it holds a certain phase. When a spin torque is injected in the free layer at a great enough density, the magnetic moment precesses and moves at microwave frequencies around the symmetry axis with ever increasing amplitude until it reverses its phase. However, the magnetic moment of the free layer cannot be precisely measured due to such factors as variance in the material composition, manufacturing, and the write current that induced the present magnetic phase. Thus, the magnetic moment of a number of MTJs in this design are random. At step 214, a precession is induced by the spin torque being injected in the free layer.

It can be appreciated by the skilled artisan that the injected spin torque will not induce every free layer to precess. As a nominally pico-second width current pulse is injected in the free layer, the free layer can precess and change phase, maintain phase but reduce the magnetic moment, or maintain phase with a substantially similar moment. Therefore, the inducement of precession at step 214 is random and is affected by several factors including, but not limited to, the magnetic moment of the free layer, the current pulse width, and the thermal noise of the MTJ.

After the spin torque has been injected in the free layer, the free layer will settle to equilibrium in a logical state at step 216. The settlement of the free layer will result from the magnetic moment becoming stable, either from changing phase or maintaining a consistent moment.

It should be noted that the final magnetization settlement state is influenced the most by the current pulse width. The pulse width variation in the pico-second range results in the random precessional magnetization settlement of a free layer of a MTJ. The addition of thermal fluctuation at finite temperature of the MTJ in this design also makes the switching process random.

Due to symmetry of the configuration, there is equal probability for the magnetization to settle down into either of the two logic states. While the direction of polarization is not limited to the perpendicular direction, perpendicular polarization provides the maximum spin torque to induce precession of the free layer. In application, the spin polarization direction can be optimized to achieve maximum spin torque to induce precession. Similarly, the spin polarized current amplitude for precessional magnetization motion can be made extremely small. The threshold current for precessional magnetization switching goes to zero as in-plane anisotropy goes to zero.

In FIG. 7, a conventional pulse width 218 is graphically represented in relation to a pulse width 220 operated in accordance with the various embodiments of the present invention. The conventional pulse width 218 has consistent amplitude from the beginning of the pulse to the end. In contrast, the pulse width 220 used in various embodiments of the present invention has an indeterminable amplitude as well as beginning and end points. This indeterminable amplitude and range result from the variance involved in various embodiments of the present invention with pulses close to pico-second width. Thus, a varying pulse width that is nominally a pico-second provides random pulse amplitude and width.

As can be appreciated by one skilled in the art, the various embodiments illustrated herein provide advantageous generation of random logical bit values for fast and reliable encryption technologies that require random numbers for various functions. Among the various encryption technologies that can use random numbers are communications and data security industries to which manual or automatic random number generation allows access to various protocols and systems, such as the device of FIG. 1.

The ability to generate random bits using current pulse width variation allows for very low current amplitude requirements. In fact, current amplitude can approach zero for zero free layer in-plane anisotropy. Moreover, an extremely fast data rate can be achieved for generating random logical bit values due to the nominally pico-second current pulse width used. However, it will be appreciated that the various embodiments discussed herein have numerous potential applications and are not limited to a certain field of electronic media or type of data storage devices.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising:
exciting a spin polarized current by flowing a pulse current through a spin polarizing material;
injecting the spin polarized current in a free layer of a magnetic tunneling junction; and
generating a random logical bit value in relation to pulse current duration variation.

2. The method of claim 1, wherein the pulse current uses spin torque to induce precessional motion in the free layer.

3. The method of claim 1, wherein the pulse current duration is nominally a pico-second.

4. The method of claim 1, wherein the pulse current duration is within the range of a pico-second to a nano-second.

5. The method of claim 1, wherein the magnetic tunneling junction comprises the free layer, a spin polarizing layer, and a reference layer.

6. The method of claim 1, wherein a plurality of pulse currents are injected in the free layer.

7. The method of claim 1, wherein the pulse current is injected in the free layer with orthogonal spin polarization.

8. The method of claim 1, wherein the spin polarizing layer comprises a magnetization that is perpendicular to a magnetization of the reference layer and free layer.

9. The method of claim 1, wherein the random logical bit value is determined in relation to a final magnetization orientation of the free layer, and wherein said pulse duration variation randomly sets the final magnetization orientation.

10. The method of claim 1, further comprising the step of reading the random logical bit value generated in the MTJ by detecting a relative resistance state of the MTJ.

11. The method of claim 10, further comprising the step of generating a random number by executing the exciting step, the injecting step, the generating the random logical bit value step, and the reading step a plurality of times, wherein the random number is derived from a plurality of random logical bit values.

12. An apparatus comprising control circuitry configured to excite a spin polarized current by flowing a pulse current through a spin polarizing layer, inject the spin polarized current in a magnetic tunneling junction comprising a free layer, reference layer, and a tunnel barrier layer between the free layer and the reference layer to generate a random logical bit value using pulse current duration variation or thermal variation.

13. The apparatus of claim 12, wherein the pulse current uses spin torque to induce precessional motion in the free layer.

14. The apparatus of claim 12, wherein the pulse current duration is nominally a pico-second.

15. The apparatus of claim 12, wherein the pulse current duration is within the range of a pico-second to a nano-second.

16. The apparatus of claim 12, wherein a plurality of pulse currents are injected in the free layer.

17. The apparatus of claim 12, wherein the pulse current is injected in the free layer with orthogonal spin polarization.

18. The apparatus of claim 12, wherein the spin polarizing layer comprises a magnetization that is perpendicular to a magnetization of the reference layer and free layer.

19. The apparatus of claim 12, wherein the random logical bit value is determined in relation to a final magnetization orientation of the free layer, and wherein said pulse duration variation randomly sets said final magnetization orientation.

20. The apparatus of claim 12, wherein the pulse current amplitude goes to zero as in-plane anisotropy goes to zero.
